(19) United States
(12) Patent Application Publication
(10) Pub. No.: US 2017/0136267 A1
(43) Pub. Date: May 18, 2017

(54) EMERGENCY ENTRANCE TOOL

(71) Applicant: Chris Hill, Lake St. Louis, MO (US)

(72) Inventor: Chris Hill, Lake St. Louis, MO (US)

(21) Appl. No.: 15/350,561

(22) Filed: Nov. 14, 2016

Related U.S. Application Data
(60) Provisional application No. 62/254,899, filed on Nov. 13, 2015.

(51) Int. Cl. A62B 3/00; E05B 19/20

(52) U.S. Cl. CPC A62B 3/005; E05B 19/20

(57) ABSTRACT

An emergency entrance tool including a body having a first end and a second end and between the ends is a middle section adapted to be readily held by hand. The first end is configured in generally an S-curve shaped portion and terminates with the sides of the S-curve shaped portion meeting at approximately a point. The second end is configured in the shape of one more hooks. Methods for using the emergency entrance tool to gain entrance to “in swing” and “out swing” doors are also provided.

### CROSS-REFERENCE TO RELATED APPLICATIONS

This application claims the benefit of U.S. Provisional Patent Application Ser. No. 62/254,899, filed Nov. 13, 2015, which is hereby incorporated herein by reference.

### STATEMENT REGARDING FEDERALLY SPONSORED RESEARCH OR DEVELOPMENT

Not applicable.

### BACKGROUND OF THE INVENTION

The subject matter described herein relates generally to emergency entrance tools for use with locked doors, especially for use by firemen and other emergency responders needing to gain entrance often in very short time intervals.

Various tools or improvisations, everything to the proverbial credit card, have been used in efforts to open a locked door in emergency situations, ideally without doing major structural damage to the door.

Among prior art devices employed, one may look to U.S. Pat. Nos. 7,690,627 and 8,851,454 for specific tools that have been developed for this purpose.

What is needed, however, is an emergency entrance tool which is compact, easy to use, effective, efficient and minimally damaging to doors and frames as it gains entrance for the emergency responder.

### BRIEF SUMMARY OF THE INVENTION

Accordingly, applicant has developed an emergency entrance tool and methods for its use which permit prompt, effective, efficient entrance to a door with a standard or traditional lock mechanism while occasioning no or only minimally damaging the door or frame in the process.

Thus, an emergency entrance tool is provided which addresses the needs and provides the advantages outlined herein. The emergency entrance tool includes, typically in an integral construction, a body having a first end and a second end. Between the ends is usually a largely flat section which is adapted to be readily held by hand. At the first end, the body is configured in generally an S-curve shape to aid in manipulating the door latch of an exterior “in swing” door. The S-curve portion terminates with the sides of the S-curve portion meeting at approximately a point or terminus. At the second end, the body is configured in the general shape of one or two hooks or hook-like portions, to aid in manipulating the door latch of an “out swing” door.

In another aspect of the invention, a method of using the emergency entrance tool described above on a locked “in swing” door is provided. In the method, an “in swing” door is optionally pulled towards the door jamb and held to assist in unlocking the door. The tool is placed at an angle so that its point is situated between the door knob and the door jamb with the S-curve sloping away from the jamb, and parallel with the key slot. The tool is rotated upwards until perpendicular with the door while being pushed in towards the door. The S-curve portion forces the tool into place, opening the door latch and positioning the door to be opened.

In yet another aspect of the invention, a method of using the emergency entrance tool described above on a locked “out swing” door is provided. In the method, an “out swing” door is optionally pushed towards the jamb and held to assist in unlocking the door. The tool is placed with the flat side of a hook portion of the tool situated over the door latch. The hook portion is dropped down to set on top of the latch; the tool is pulled out perpendicular from the door, thus opening the door latch so that the door can be opened.

### BRIEF DESCRIPTION OF THE DRAWINGS

The presently disclosed subject matter will be better understood from reading the following description of non-limiting embodiments, with reference to the attached drawings, wherein below:

FIG. 1 is a top perspective view of the emergency entrance tool in accordance with an exemplary embodiment of the present invention.

FIG. 2 is a front perspective view of the emergency entrance tool shown in FIG. 1.

FIG. 3 is a schematic depiction of the emergency entrance tool shown in FIGS. 1 and 2 in which the S-curve and point of the tool are depicted being engaged with the door latch of an “in swing” door so that the door can be unlocked and opened.

### DETAILED DESCRIPTION OF THE INVENTION

The foregoing summary, as well as the following detailed description of certain embodiments will be better understood when read in conjunction with the appended drawings. As used herein, an element or step recited in the singular and proceeded with the word “a” or “an” should be understood as not excluding the plural of said elements or steps, unless such exclusion is explicitly stated. Furthermore, references to “one embodiment” or “an embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Various embodiments as described and shown herein provide an emergency entrance tool providing the benefits described herein and addressing emergency entrance concerns and issues inexpensively and efficiently which had not heretofore been addressed.

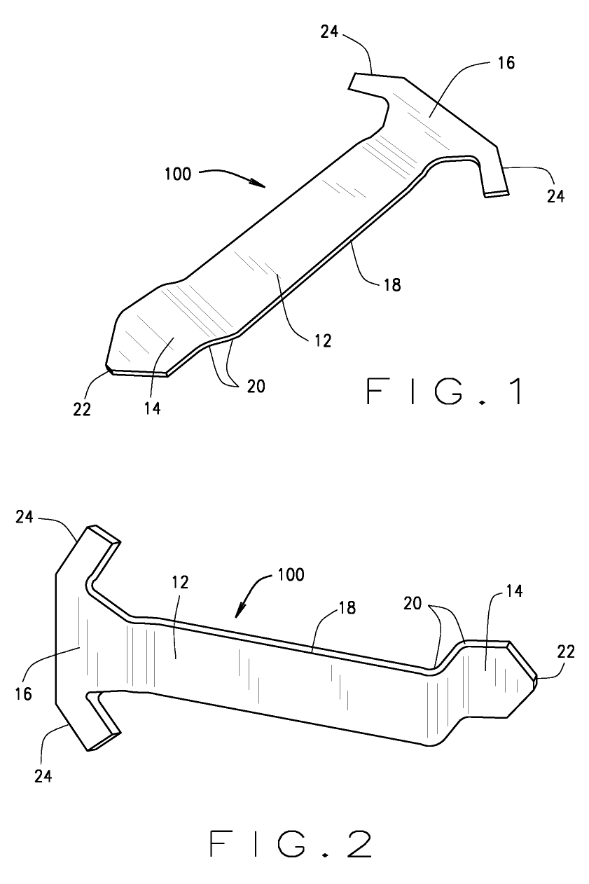

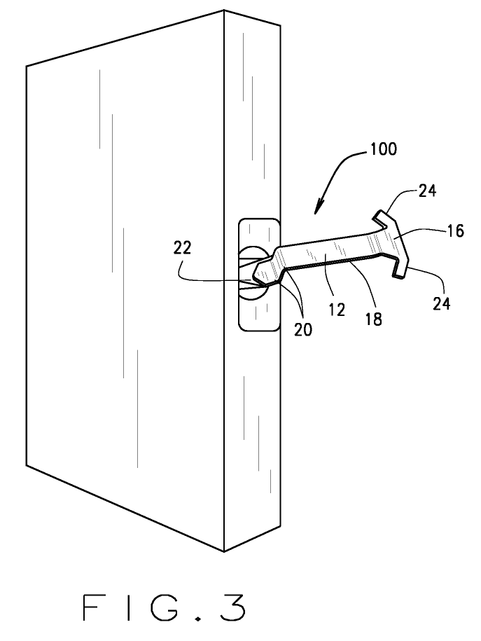

Referring to the drawings, in one embodiment of the invention, an emergency entrance tool 100 may be seen in FIGS. 1-2.

In the embodiment shown in FIGS. 1 and 2, the emergency entrance tool 100 includes a body 12 having a first end 14 and a second end 16. Between the ends is a largely flat mid-section 18, although other configurations can be employed, which is adapted to be readily held by hand. At the first end 14, the body 12 is configured in generally an S-curve shaped portion 20 to aid in manipulating the door latch of an exterior “in swing” door. The S-curve portion 20 terminates with the sides of the S-curve portion narrowing to meet at approximately a point or terminus 22. At the second end, the body is configured in the general shape of one or two hooks or hook-like portions 24 to aid in manipulating the door latch of an “out swing” door. Of course, in certain embodiments, the tool is separated out into just the point/S-curve and handle, or the hook(s) and handle.

The emergency entrance tool can be made out of a variety of metals of sufficient strength and durability through a simple process of stamping a blank out of a sheet of the metal and bending the blank into the desired specific shape. Alternatively, a die or mold may be employed and metal, hard plastics or other materials formable to the desired dimensions and requirements for the purposes described herein, which are known to those skilled in the tool and die art, may be employed to make the contemplated tools.

The emergency entrance tool of the invention is shaped with specific bends and hooks to more effectively and efficiently create a shape that allows for easier access to the latch and guides it to push the latch in the proper direction. At the same time, the emergency entrance tool is configured so that when in use, it is minimally, or not at all, damaging to the door and frame. In particular, the S-curve and point are configured to maximally engage and manipulate the door latch of an exterior “in swing” door. Similarly, the hooks are configured to maximally engage and manipulate the door latch of an “out swing” door.

The emergency entrance tool 100 is employed according to an embodiment of one method to unlock and open a locked “in swing” door. In this embodiment, an “in swing” door is optionally pulled towards the door jamb and held for ease of manipulation. The tool 100 is placed at an angle so that its point 22 is situated between the door knob and the door jamb with the S-curve portion 20 sloping away from the jamb, and parallel with the key slot. The tool 100 is rotated upwards until perpendicular with the door while being pushed in towards the door. The S-curve portion 20 forces the tool into place, opening the door latch and opening the door.

The emergency entrance tool 100 described above is also employed to unlock and open a locked “out swing” door. In an embodiment of this method, an “out swing” door is optionally pushed towards the jamb and held for ease of manipulation. While (optionally) the door is being held, the tool 100 is placed with the side of a hook portion 24 of the tool 100 situated over the door latch. The hook portion 24 is dropped down to set on top of the latch; the tool 100 is pulled out perpendicular from the door, thus opening the door.

Thus, this invention in its various embodiments serves to inexpensively, effectively and efficiently open locked doors, especially when needed by emergency responders, and while incurring minimal or no structural damage.

It is to be understood that the above description is intended to be illustrative, and not restrictive. For example, the above-described embodiments and/or aspects thereof may be used in combination with each other. In addition, many modifications may be made to adapt a particular situation or material to the teachings of the various embodiments of the invention without departing from their scope. While the dimensions and types of materials described herein are intended to define the parameters of the various embodiments of the invention, the embodiments are by no means limiting and are exemplary embodiments. Many other embodiments will be apparent to those of skill in the art upon reviewing the above description. The scope of the various embodiments of the invention should, therefore, be determined with reference to the appended claims, along with the full scope of equivalents to which such claims are entitled. In the following claims, the terms “first,” or “second,” etc. are used merely as labels, and are not intended to impose numerical requirements on their objects.

This written description uses drawings and examples of components to disclose various embodiments of the invention, and also to enable any person skilled in the art to practice the various embodiments of the invention, including making and using any devices and performing incorporated methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed is:

1. An emergency entrance tool comprising a body having a first end and a second end, a middle section between the ends adapted to be readily held by hand, the first end being configured in generally an S-curve shaped portion and terminating with the sides of the S-curve shaped portion meeting at approximately a point, the second end, being configured in the shape of one or more hooks.

2. The tool of claim 1 having an integral construction.

3. The tool of claim 1 having at least two hooks on the second end.

4. An emergency entrance tool comprising a body having a first end and a second end, a middle section between the ends adapted to be readily held by hand and either the first end or the second end being configured in generally an S-curve shaped portion and terminating with the sides of the S-curve shaped portion meeting at approximately a point, or being configured in the shape of one or more hooks.

5. The tool of claim 4 having an integral construction.

6. The tool of claim 4 configured in the shape of at least two hooks on either the first end or the second end.

7. A method of using an emergency entrance tool comprising a body having a first end and a second end, a middle section between the ends adapted to be readily held by hand, the first end being configured in generally an S-curve shaped portion and terminating with the sides of the S-curve shaped portion meeting at approximately a point, the second end, being configured in the shape of one or more hooks on a locked door, the method comprising the steps of determining if the door is an “in swing” door or an “out swing” door, upon determining that the door is an “in swing” door, placing the tool at an angle so that its point is situated between the door knob and the door jamb with the S-curve sloping away from the jamb and parallel with the key slot, rotating the tool upwards until perpendicular with the door while being pushed in towards the door, and using the S-curve portion of the tool to force the tool into place, whereby the door latch is moved to its open position, and upon determining that the door is an “out swing” door, placing the tool with the flat side of a hook portion of the tool situated over the door latch, dropping the hook portion down to set on top of the latch, and pulling out the tool perpendicular from the door, whereby the door latch is moved to its open position.

8. The method of claim 7 further comprising pulling the door towards the door jamb and holding the door against the door jamb to assist in moving the door latch to its open position.
